(19) United States
(12) Patent Application Publication
(10) Pub. No.: US 2015/0124385 A1
(43) Pub. Date: May 7, 2015

(54) Smart Electronic Device

(71) Applicant: Ching Yi Chan, (US)

(72) Inventors: Ka Chun Mak, Hong Kong (HK); Ching Yi Chan, Hong Kong (HK)

(73) Assignee: Ching Yi Chan, Hong Kong (HK)

(21) Appl. No.: 14/249,370

(22) Filed: Apr. 10, 2014

Related U.S. Application Data
(60) Provisional application No. 61/899,284, filed on Nov. 3, 2013.

(51) Int. Cl. G06F 1/16

(52) U.S. Cl. CPC G06F 1/162; G06F 1/163; G06F 1/1622
USPC 361/679.03; 361/679.05

(57) ABSTRACT

The present application is directed to a smart electronic device, including a case, a display panel, a bar, a hinge and a rotating plate. The bar includes at least a proximal bar part and a distal bar part, and a bar adjusting component configured to adjust the relative positions of the proximal bar part and the distal bar part. The proximal bar part and the distal bar part slidingly connects. The proximal bar part connects to the case through the hinge. The distal bar part connects to the display panel through the rotating plate.

### CROSS-REFERENCE TO RELATED APPLICATIONS

This present application claims the benefit of U.S. Provisional Patent Application No. 61/899,284 filed on Nov. 3, 2013; the contents of which are hereby incorporated by reference.

### FIELD OF THE TECHNOLOGY

The present application relates to an electronic product, specifically, to a smart electronic device whose display panel and case can be adjusted for convenient use.

### BACKGROUND

Smart electronic devices, such as smart phone, tablet PC and the like are popular, and are becoming indispensable among daily lives of city dwellers. The smart electronic devices provide the users with entertainment, information and means of communication etc. In order to grasp the most updated information and seize more time for entertainment and work, the smart electronic devices are becoming necessities. Contemporary smart electronic devices usually have an integrated display panels and case, rendering a relatively weightiness of the whole product. Furthermore, the smart electronic devices must be hand held during usage. Hence, prolonged use of these products would not only cause fatigue of the hands, arms and shoulders, but would also cause muscle pain. In more serious case, such would lead to bodily injury. In addition, the users cannot perform other tasks simultaneously, such as holding the umbrella, searching for the wallet when holding the smart electronic devices. Thus, this would lead to inconvenience. If the smart electronic devices are dropped on the ground negligently, damage would be caused. Yet, even placing the smart electronic devices on the table also requires the use of hands or auxiliary stands to hold the smart electronic devices in place at a definite angle which enables the same to be presented in front of the users. As a result, the use of the smart electronic devices brings about many inconveniences among users.

### SUMMARY

The present patent application is directed to a smart electronic device. In one aspect, the smart electronic device includes a case, a display panel, a bar, a hinge and a rotating plate. The bar includes at least two bar parts, the bar parts include at least a proximal bar part and a distal bar part, and a bar adjusting component configured to adjust a relative position between the bar parts, the adjacent bar parts are slidingly connected which allows a length of the bar to be adjustable. The proximal bar part connects to the case through the hinge, which allows the angle between the display panel and the case to be adjustable. The distal bar part connects to the display panel through the rotating plate, which allows the display panel and the distal bar part to rotatably connect.

The smart electronic device further includes a rotating component configured to enable the display panel to rotate in relative to the case. The rotating component is provided on the bar, hinge or case, or is provided between the bar and the hinge, or between the case and the hinge.

The case is provided with at least one support plate, the support plate is configured to be retracted within the case; the support plate extends outwardly from the case when in use; the case is provided with a support plate adjusting component configured to adjust the relative positions of the support plate and the case.

The smart electronic device further comprises a neck cord and/or a waist belt to enable the smart electronic device to be hung on the user's body; wherein the neck cord and/or waist belt is provided on the case, bar or display panel.

The bar is provided with a balancing component, the neck cord is connected to the balancing component.

A back of the display panel is provided with a supplementary display unit and/or an indicating light, and a gravity sensing sensor is provided in an interior of the display panel.

A clip is provided on the case, bar, hinge or display panel to attach onto an object to be attached.

A battery, a main board and a receiver is provided within the case , the main board and/or display panel are further provided with a keyboard, a camera, a sound control key, an on/off switch, an ear plug socket, a USB socket or an amplifier.

The hinge is provided with a hinge adjusting component configured to adjust an angle between the bar and the case.

The bar is provided with a wireless transmission device, the wireless transmission device connects to the case electrically.

The smart electronic device further comprises an adjusting strut, an upper end of the adjusting strut rotatably connects to the display panel or the bar, wherein the back of the case is provided with a plurality of adjusting grooves that couple with the adjusting strut.

The display panel is a folded display panel, the display panel comprises a plurality of display units that can be folded.

The smart electronic device has a retracted space for retracting the neck cord and/or waist band.

The smart electronic device further comprises an electronic component for driving a sliding of the bar parts and driving a rotation of the hinge and the rotating plate.

The smart electronic device further comprises an electronic component for driving a rotation of the rotating component.

The upper end of the distal bar part of the bar connects to the display panel through the rotating plate, which allows the display panel and the distal bar part to be rotatably connected.

The lower end of the proximal bar part of the bar connects to the case through the hinge, which allows the angle between the display panel and the case to be adjustable.

A groove is provided to one side of case opposite to the display panel, which allows the bar facing the display panel to retract within the groove when the display panel and the case fold together.

### BRIEF DESCRIPTION OF THE DRAWINGS

FIG. 1 is a front perspective of a smart electronic device being placed on a flat surface according to a first embodiment of the present application.

FIG. 2 is a rear perspective of a smart electronic device being placed on a flat surface according to the first embodiment of the present application.

FIG. 3 is a side illustrative view of the smart electronic device shown in FIG. 1 whose bar is in the shortest length.

FIG. 4 is a side illustrative view of the smart electronic device shown in FIG. 1 whose bar is in the longest length.

FIG. 5 shows the angle of the bar relative to the case being adjusted for the smart electronic device shown in FIG. 1.

FIG. 6 shows the display panel being in a vertical position in relative to the bar of the smart electronic device shown in FIG. 1.

FIG. 7 shows the display panel being in a horizontal position in relative to the bar of the smart electronic device shown in FIG. 1.

FIG. 8 shows the location of the rotating component and the rotating axis of the display panel of the smart electronic device shown in FIG. 1.

FIG. 9 shows the rotation of the rotating component and the display panel of the smart electronic device shown in FIG. 1.

FIG. 10 shows the display panel of the smart electronic device shown in FIG. 1 being rotated to an upwardly faced direction.

FIG. 11 shows the display panel of the smart electronic device shown in FIG. 1 being rotated to a downwardly faced direction.

FIG. 12 shows the display panel of the smart electronic device shown in FIG. 1 being rotated to an upwardly faced direction and folded with the case.

FIG. 13 shows the display panel of the smart electronic device shown in FIG. 1 being rotated to a downwardly faced direction and folded with the case.

FIG. 14 and FIG. 15 show the smart electronic device being hung on the neck of the user through the neck cord according to a second embodiment of the patent application.

FIG. 16 shows the smart electronic device being hung on the neck of the user through the neck cord according to a third embodiment of the patent application.

FIG. 17 is a perspective view of the smart electronic device according to a fourth embodiment of the present application.

FIG. 18 shows the display panel of the smart electronic device according to a fifth embodiment of the present application being in a folded position.

FIG. 19 shows the display panel of the smart electronic device according to the fifth embodiment of the present application being in an un-folded position.

### DETAILED DESCRIPTION

Reference will now be made in detail to a preferred embodiment of the smart electronic device disclosed in the present patent application, examples of which are also provided in the following description. Exemplary embodiments of the smart electronic device disclosed in the present patent application are described in detail, although it will be apparent to those skilled in the relevant art that some features that are not particularly important to an understanding of the smart electronic device may not be shown for the sake of clarity.

In the description of the smart electronic device of the present application, it should be understood that the words “front,” “rear,” “top,” “bottom,” “upper end,” “lower end,” “upper part,” “lower part” as such position indications or location relationships are the positions or location relationships illustrated in the drawings. They are simplified terms for ease of description of the present application, and do not indicate or imply that the device or component must necessarily possess the specified positions, and form and operate with the specified positions. Hence, they cannot be treated as limitations to the present application. Furthermore, the terms “the first,” “the second” etc. are merely used for describing the purpose and should not be taken as indications or implications of relative importance.

The smart electronic device in the present application can be portable computers, tablet PCs, smart phones, smart terminals, game machine and other various kinds of smart electronic devices.

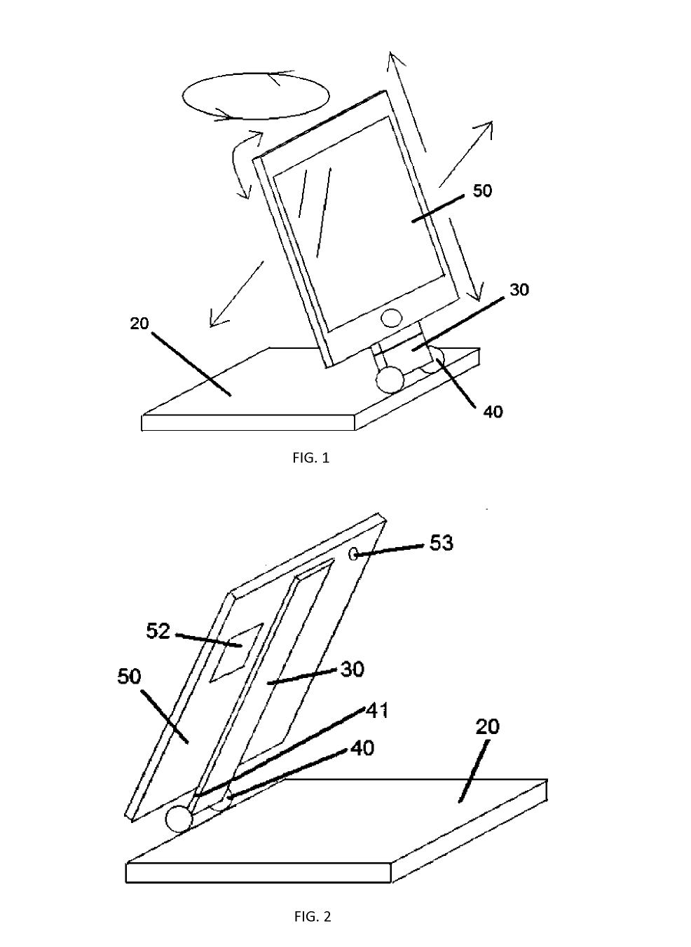

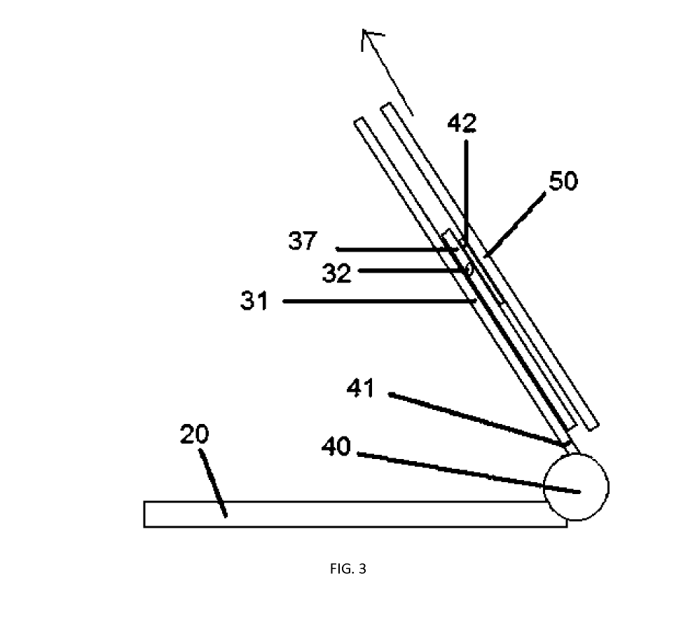

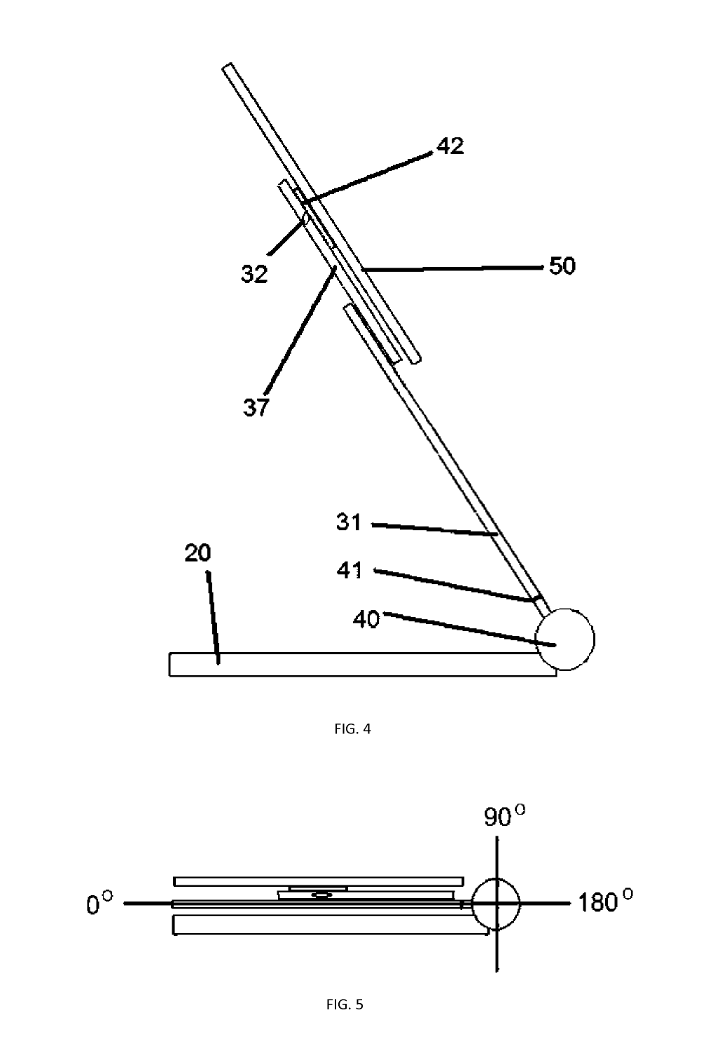

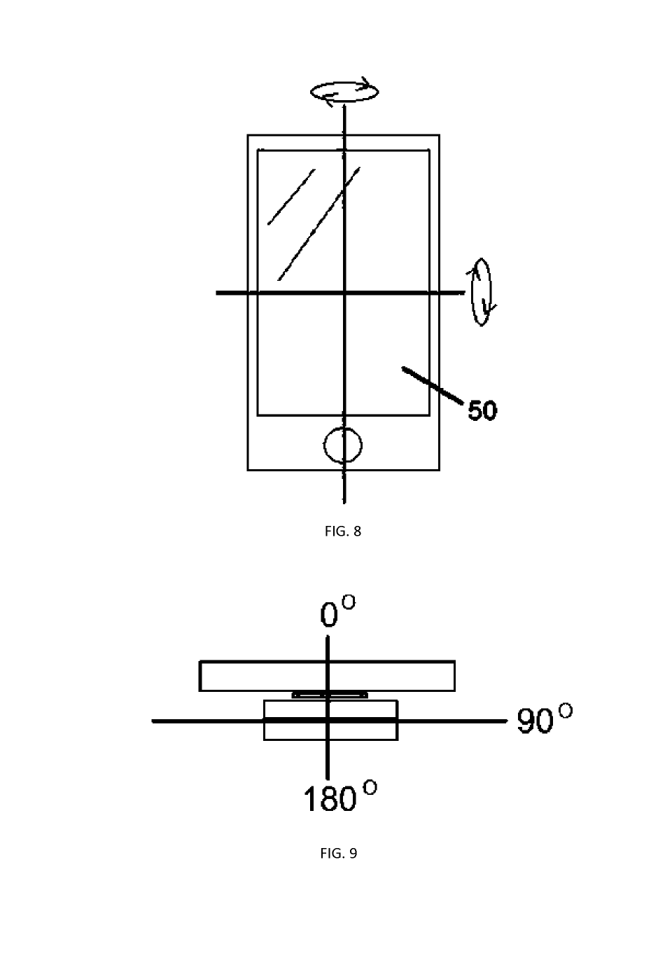

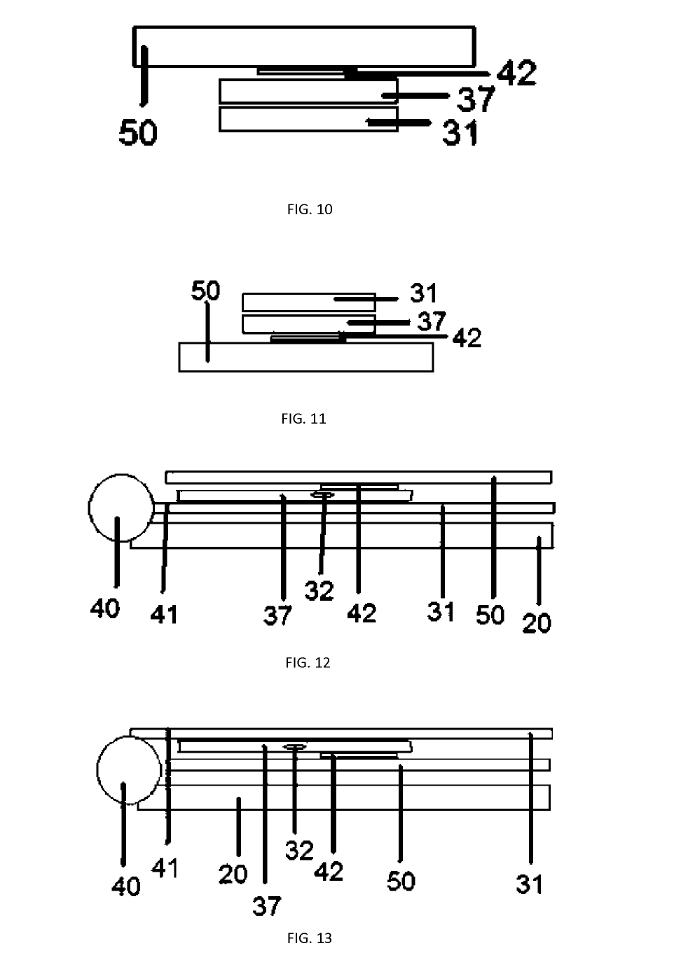

FIGS. 1 to 13 illustrate the smart electronic device according to a first embodiment of the present application. The smart electronic device includes a case 20, a bar 30, a hinge 40, a rotating plate 42 and a display panel 50. The lower end of the bar 30 connects to the case 20 via the hinge 40. The upper end of the bar 30 connects to the display panel 50 via the rotating plate 42. The length of the bar 30 can be extended or retracted as needed. Specifically, in the present embodiment, the bar 30 includes at least two bar parts, a proximal bar part 31 and a distal bar part 37. The bar 30 also includes a bar adjusting component 32 configured to adjust the relative position of the proximal bar part 31 and the distal bar part 37. The proximal bar part 31 and the distal bar part 37 are slidingly connected in the present embodiment. A rotatable hinge 40 connects between the lower end of the proximal bar part 31 and the case 20. The user can adjust the angle between the display panel 50 and the case 20. The upper end of the distal bar part 37 connects to the display panel 50 via the rotating plate 42. It is possible to rotate the display panel 50 on the bar 30 in relative to the case 20. It should be emphasized that the upper end of the bar 30 connects to the display panel 50 by the rotating plate 42 is merely an example The bar 30 can be connected to the display panel 50 and the rotating plate 42 at any location. Similarly, the lower end of the bar 30 and the case 20 is connected by the rotatable hinge 40 is merely an example, the bar 30 can be connected to the case 20 at any location.

As FIGS. 1 to 4 illustrate, the smart electronic device can have at least one bar 30. The bar 30 includes two or more bar parts. A bar adjusting component 32 is provided on the bar 30. The position between each bar part in the bar 30 can be adjusted through pushing, pulling or sliding bar part, which changes the length of the bar 30. Thus, the distance between the display panel 50 located on the distal bar part 37 and the case 20 can be adjusted. The bar 30 can use a plurality of bar parts in a nested structure, a folded structure, an organ structure or other commonly suitable structures. In the present embodiment, the bar 30 use a folded structure in a slidingly connected method. A plurality of bar parts folds together, which can mutually pull apart from or overlap with each other. The length of the bar 30 can be changed by adjusting the position of each bar part. When the bar parts are pulled apart, the length of the bar 30 is the longest, when the bar parts are retracted together, the length of the bar 30 is the shortest. The length of the bar 30 can be adjusted between the longest or shortest length. The bar adjusting component 32 can be in a structure of a button, a knob and, elastic part or other commonly suitable structures. In the present embodiment, the bar adjusting component 32 is in a button structure. Manipulate the bar adjusting component 32 can push and/or pull the bar parts. When the user presses down the bar adjusting component 32, the bar 30 is in a length adjustable status. The demanded length of the bar 30 can be achieved by pulling apart the bar part or retracting the bar part. The length of the bar 30 can maintain at that length when the bar adjusting component 32 is released. The user can adjust the length of the bar 30 as needed, so as to adjust the distance between the display panel 50 on the distal bar part 37 and the case 20. The longer the length of the bar 30, the further the distance between the display panel 50 and the case 20. Conversely, the shorter the length of the bar 30, the closer the distance between the display panel 50 and the case 20.

A wireless transmission device can be provided within the bar 30 of the smart electronic device. The wireless transmission device electronically connects to the case 20. This can enhance the function of wireless receiving and sending the signal, data, electric power etc between the smart electronic device and the external device.

Referring to FIGS. 1 to 13, a rotatable hinge 40 connects between the proximal bar part 31 and case 20 of the smart electronic device. The display panel 50 on the bar 30 can rotatably connect to the case 20 so that the user can adjust the angle or multi-directed angles between the display panel 50 and the case 20 (the slanted angle of the display panel 50 in relative to the case 20). Furthermore, the display panel 50 and the case 20 can be folded together. The rotatable hinge 40 can be in a commonly suitable structure such as a rotating axis or beads. The hinge 40 may have a rotation friction and/or damping that obstruct the hinge 40 to rotate.

The user needs to use a slight force in order to adjust the angle of the hinge 40. Such would ensure the angle of the hinge 40 can be adjustable, and at the same time prevent the hinge 40 from rotating automatically in use.

Referring to FIGS. 1 to 13, the rotating plate 42 is provided between the distal bar part 37 of the bar 30 and the display panel 50 of the smart electronic device. The rotating plate 42 can rotate. The user can rotate the rotating plate 42 so as to allow the display panel 50 to rotate on the bar 30. The display panel 50 can thus be vertically or horizontally located on the bar 30 and not be limited to the length of the bar 30. This would accommodate different needs under different conditions. The rotating plate 42 has a rotating friction and/or damping that obstructs the rotating plate 42 to rotate, and the user needs to use a slight force in order to adjust the angle of the rotating plate 42. Such would ensure the rotating plate 42 to rotate, and also prevent the rotating plate 42 from automatically rotating when use.

Referring to FIGS. 1 to 13, the rotating component 41 is provided on the proximal bar part 31 or between the case 20 and the hinge 40. Or the rotating component 41 is provided on the bar 30. Or the rotating component 41 is provided on the hinge 40. Or the rotating component 41 is provided on the case 20. In short, the rotating component 41 can be located at the bar 30, hinge 40, case 20 or therebetween. The display panel 50 can be fold internally or externally with the case 20 by rotating the rotating component 41. The left and right or up and down or multi-directed angles of the display panel can be adjusted by rotating the rotating component 41. In the present embodiment, the rotating component 41 is provided within the bar 30. The rotating axis of the rotating component 41 is the vertical central axis or the horizontal central axis of the display panel 50. The display panel 50 can take the rotating component 41 as the main axis. The user can flexibly allow the display panel 50 to face externally and fold with the case 20, for his ease of usage. Alternatively, the display panel 50 can face internally and fold with the case 20 when necessary. The case 20 can protect the display panel 50, and can adjust the left and right or up and down or multi-directed angles of the display panel 50. The rotating component 41 can be in a commonly suitable structure such as a rotating axis or beads. The rotating component 41 has a rotation friction and/or damping friction that obstruct the rotating component 41 to rotate. The user needs to use a slight force in order to adjust the angle of the rotating component 41. It can ensure the rotating component 41 to be able to rotate, and at the same time prevent the rotating component 41 from automatically rotating during the process of usage.

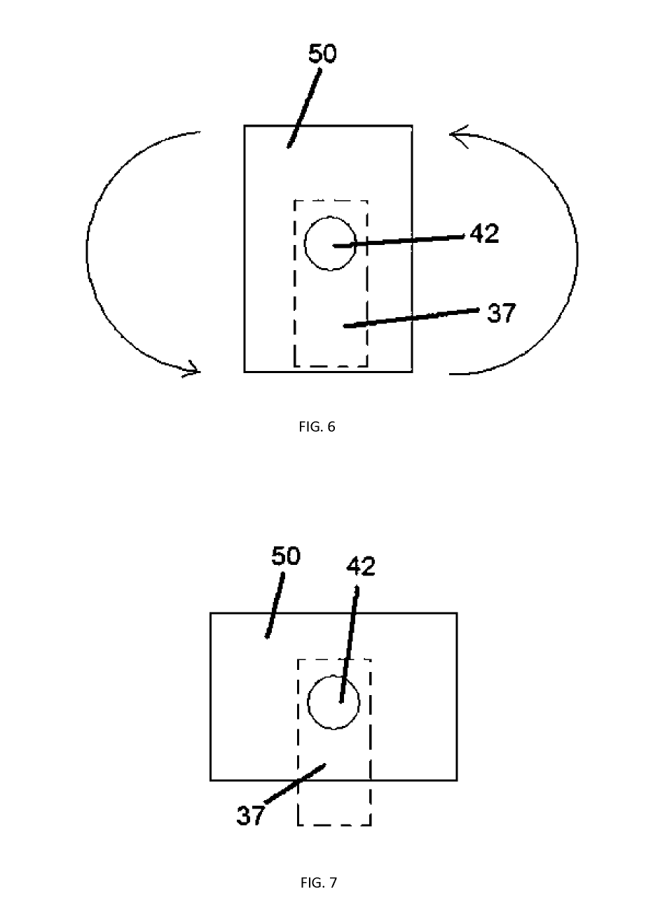

Referring to FIGS. 6 and 7, a weight sensing device is provided within the display panel 50. The weight sensing device can transmit the standing angle information of the display panel 50 to the processor, allowing the display content of the display panel 50 to be adjusted to a suitable angle according to position of the display panel 50.

A battery, electrical circuit board and receiver, and other electronic parts are provided within the case. Other external accessories can also be provided with the exterior of the case 20 and/or display panel 50, such as a keyboard, a camera, a sound control key, an on/off switch, an ear plug socket, USB socket, and an amplifier. The power source line and signal line that are connected between the case 20 and the display panel 50 can be connected to the bar 30 and the display panel 50, directly or through the hinge 40, allowing the case 20 to supply power source to the display panel 50 and exchange information with each other. The display panel 50 can be a touch panel, which can input information through touch to operate. Furthermore, the side of the case 20 opposite to the display panel 50 is provided with a groove. When folding the display panel 50 and the case 20, the bar 30 facing the case 20 can retract within the groove.

Referring to FIG. 2, the back of the display panel 50 of the smart electronic device can be installed with an indicating light 53 and/or a supplementary display unit 52. Even when the display panel 50 is internally folding with the case 20, the indicating light 53 and/or supplementary display unit 52 at the back of the display panel 50 can still notify the immediate message to the user.

A hinge adjusting component is provided on the hinge 40 of the smart electronic device. Manipulation of the hinge adjusting component can rotate the hinge 40. When the user presses down the hinge adjusting component, the hinge 40 would be in an angle adjustable status. The required angle between the case 20 and the display panel 50 can be attained through rotating the rotating hinge 40. When the hinge adjusting component is released, the angle between the case 20 and the display panel 50 can be maintained.

The operation of the sliding of the bar 30, and the rotation of the hinge 40, rotating plate 42 and rotating component 41 can be electronically controlled. The smart electronic device can include a first electronic component configured to drive the sliding of the bar part and a second electronic component configured to drive the rotation of the hinge, rotating plate and rotating component.

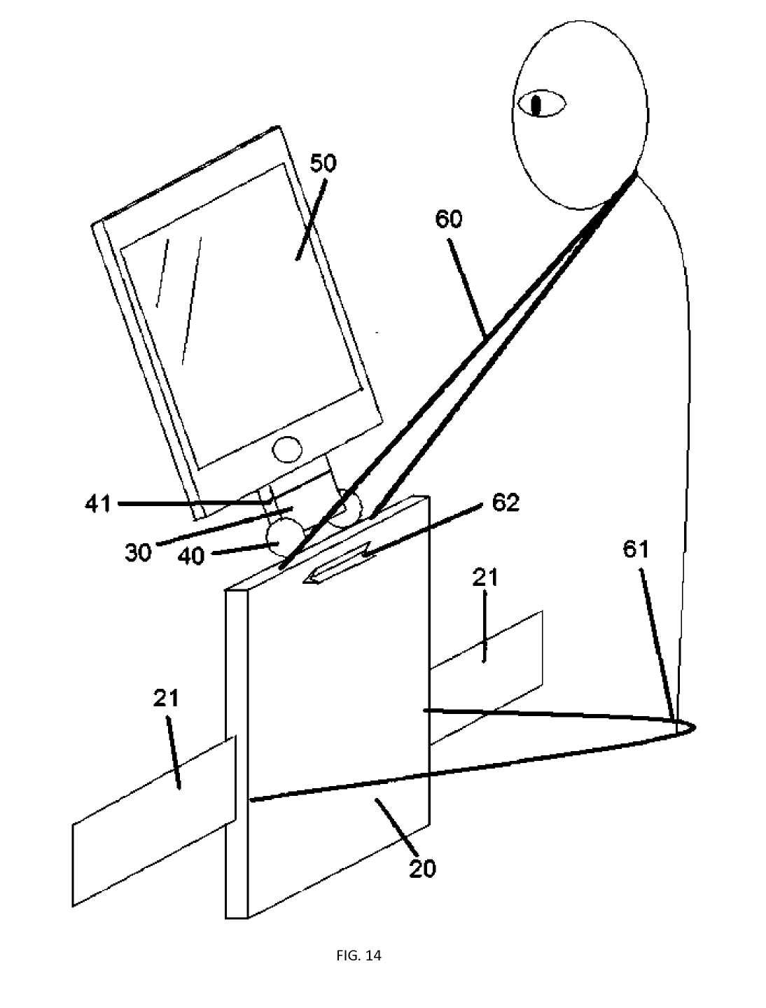

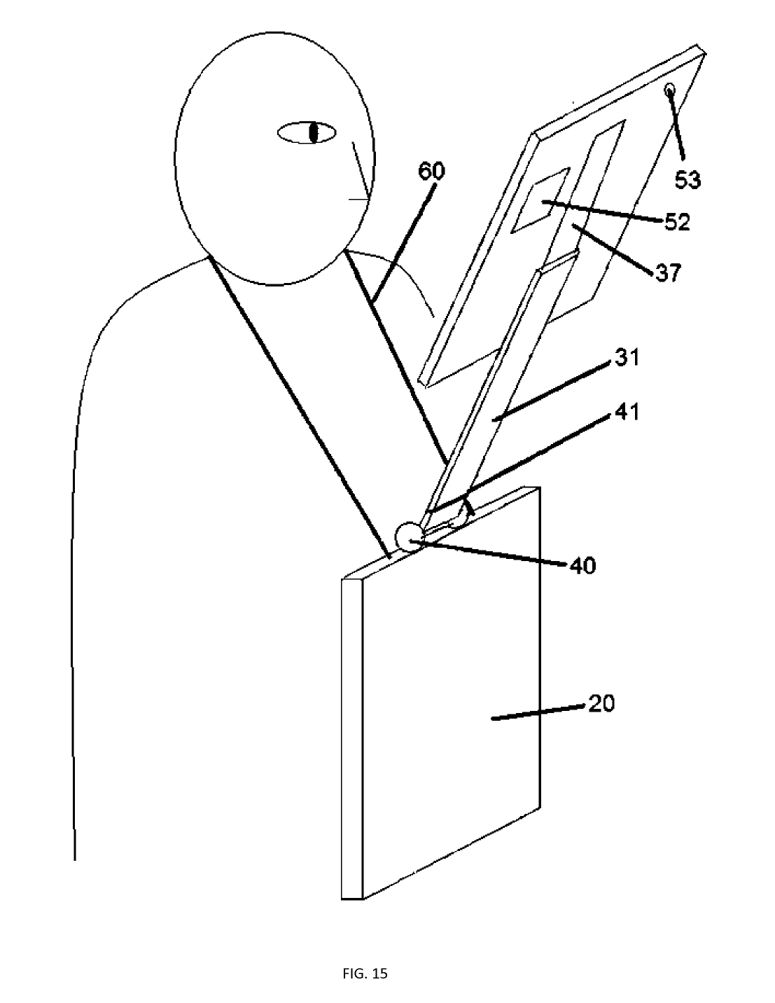

FIGS. 14 and 15 are illustrative views of the second embodiment of the smart electronic device of the present application. For convenient use and freeing both hands of the user, the smart electronic device also includes a neck cord 60, comparing with the first embodiment. The neck cord 60 can be provided on the case 20, the bar 30 or the display panel 50. In the present embodiment, the neck cord 60 is provided on the case 20. The neck cord 60 can be fixedly or detachably connected to the case 20. The user can hang the smart electronic device on his/her neck using the neck cord 60, causing the smart electronic device on the neck cord 60 to be suspended before the user, such as on his/her abdomen. The display panel 50 can be raised before the user by adjusting the angle between the display panel 50 and the case 20. Further adjustment is made on the distance between the display panel 50 and the case 20 using the bar 30, so as to allow the display panel 50 to be able to stand erect before the user at a suitable angle and distance. Thus, the user can operate the smart electronic device without the need to use his/her hands.

Furthermore, a waist belt 61 can be fixedly or detachably provided on the case 20. After the waist belt 61 being connected to the smart electronic device or neck cord 60, it encircles the waist of the user. It can allow the smart electronic device hung on his/her body to be more stabilized, and enhance the stability of the smart electronic device when being hung on the user's body. The smart electronic device has a retracted space configured to retract the neck cord and/or waist belt. The neck cord 60 and the waist belt 61 of the smart electronic device can be retracted within the smart electronic device, which can be pulled out for usage. A clip 62 can be provided on the case 20, bar 30, hinge 40 or display panel 50 of the smart electronic device for clipping, sticking and buckling on the object to be attached. For example, the clip 62 can be clipped on the clothing of the user, for enhancing the stability of the smart electronic device when being hung on the body of the user.

Referring to FIGS. 14 and 15, the smart electronic device can include one or a plurality of support plates 21 situated within the case 20. The case 20 can also be provided with a support plate adjusting component. Through manipulation of the support plate adjusting component, the extension and/or retraction of the support plate 21 within the case 20 can be realized. When an additional support is required, the user can manipulate the support plate adjusting component to make the support plate 21 extend outwardly. This can increase the support area towards the case 20, so as to minimize the situation of sideway shaking of the smart electronic device due to the motion of the user. When the support plate 21 is not required, the support plate adjusting component can be again manipulated so that the support plate 21 is resumed to be retracted within the case 20. The support plate 21 would not increase the volume of the smart electronic device, making it convenient to be reserved and carried.

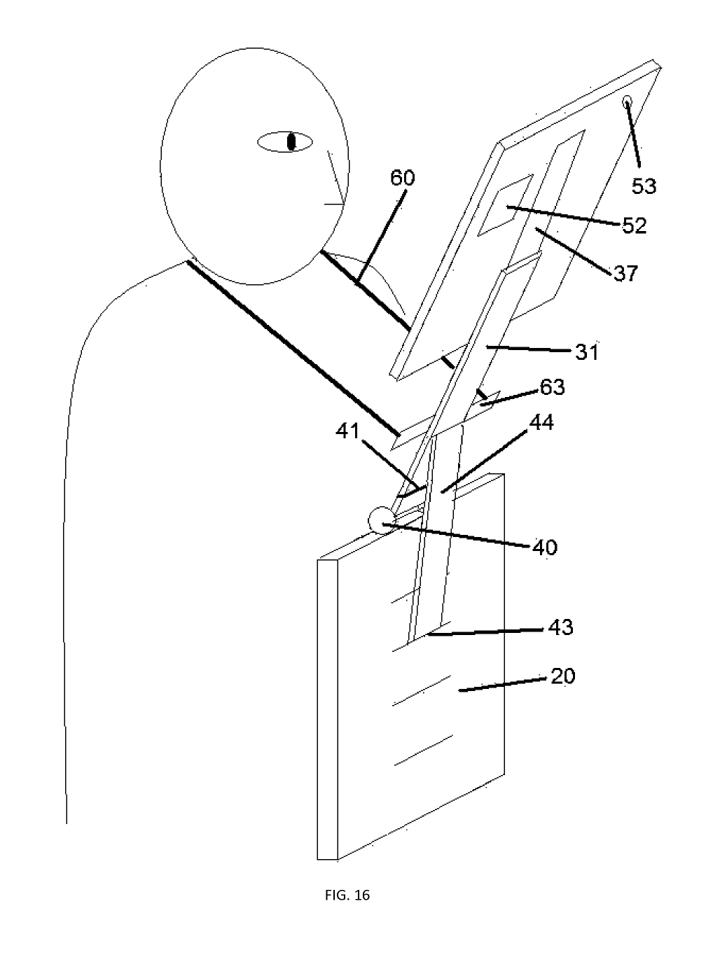

FIG. 16 shows a smart electronic device according to a third embodiment of the present application showing. Comparing with the second embodiment, an adjusting strut 44 is provided between the case 20 and the display panel 50 in the present embodiment. The upper end of the adjusting strut 44 is rotatably connected to the display panel 50 or bar 30. The back of the case 20 is provided with a plurality of adjusting grooves 43 that couple with the adjusting strut 44. The lower end of the adjusting strut 44 can be inserted into the adjusting grooves 43. The angle between the case 20 and the display panel 50 can be flexibly adjusted through inserting the end of the adjusting strut 44 to the groove 43. It should be understood that one end of the adjusting strut 44 can also be rotatably connected to the display panel 50. A plurality of grooves 43 is provided on the case 20. Through adjusting different locations which strut 44 being inserted into the grooves 43, the angle between the display panel 50 and the case 20 can be flexibly adjusted as needed.

Referring to FIG. 16, in the present embodiment, the bar 30 can be provided with a balancing component 63. The neck cord 60 connects to the balancing component 63. The balancing component 63 can change with a position change of the distal bar part 37 and the display panel 50 on the bar 30. The change ratio is not necessarily the same. The unbalancing or unstable situation caused by change of position of display panel 50 on bar 30 can be minimized.

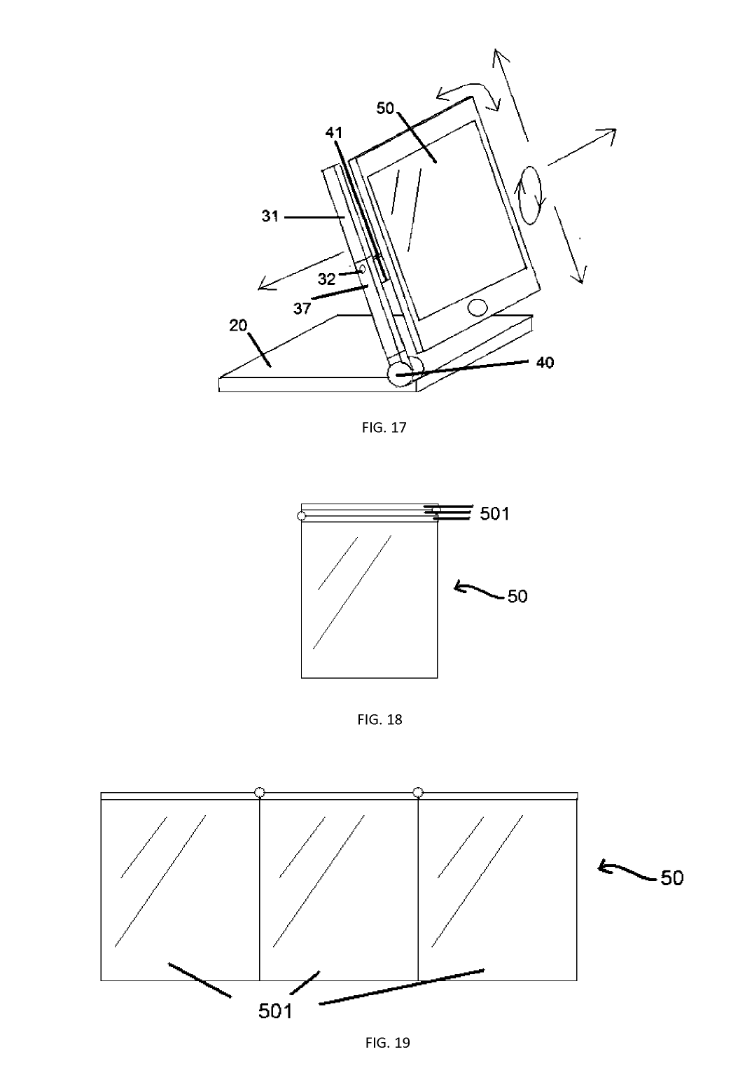

FIG. 17 shows the smart electronic device according to a fourth embodiment of the present application. In this embodiment, the bar 30 is located at one side of the case 20. When the display panel 50 and the case 20 are folded together, the bar 30 is located at a position besides the case. The other structures of the smart electronic device are the same with that of the first embodiment, and will not be reiterated.

FIGS. 18 and 19 show the display panel of the smart electronic device according to the fifth embodiment of the present application. The display panel 50 on the smart electronic device can include two or more display units 501. The display units 501 can be folded together or extended outward. When the area of the display panel 50 does not need to be increased, the display units 501 can be under a folded status for ease storage and carriage. When the area of the display panel 50 needs to be increased, the display unit 501 can be extended outwardly. The present application allows the user to use the smart electronic device more conveniently and flexibly, and ultimately increases the usage of the smart electronic device. The user's time is saved. Higher rate of the productivity is promoted. The chance of fatigue and muscle injury of the user's hands, arms and shoulders caused by prolonged time of using the smart electronic device is reduced. Furthermore, damages of the smart electronic device caused by negligently dropping on the ground are minimized.

It should be understood that the smart electronic device disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

1. A smart electronic device, comprising:
a case;
a display panel;
a bar;
a hinge; and
a rotating plate;
wherein the bar comprises at least two bar parts, the bar parts comprise at least a proximal bar part and a distal bar part, and a bar adjusting component configured to adjust a relative position between the bar parts, the adjacent bar parts are slidingly connected which allows a length of the bar to be adjustable;
the proximal bar part connects to the case through the hinge, which allows the angle between the display panel and the case to be adjustable; and
the distal bar part connects to the display panel through the rotating plate, which allows the display panel and the distal bar part to rotatably connect.

2. The smart electronic device according to claim 1, further comprising a rotating component configured to enable the display panel to rotate in relative to the case; wherein the rotating component is provided on the bar, hinge or case, or is provided between the bar and the hinge, or between the case and the hinge.

3. The smart electronic device according to claim 1, wherein the case is provided with at least one support plate, the support plate is configured to be retracted within the case; the support plate extends outwardly from the case when in use; the case is provided with a support plate adjusting component configured to adjust the relative positions of the support plate and the case.

4. The smart electronic device according to claim 1, further comprising a neck cord and/or a waist belt to enable the smart electronic device to be hung on the user's body; wherein the neck cord and/or waist belt is provided on the case, bar or display panel.

5. The smart electronic device according to claim 4, wherein the bar is provided with a balancing component, the neck cord is connected to the balancing component.

6. The smart electronic device according to claim 1, wherein a back of the display panel is provided with a supplementary display unit and/or an indicating light, and a gravity sensing sensor is provided in an interior of the display panel.

7. The smart electronic device according to claim 1, wherein a clip is provided on the case, bar, hinge or display panel to attach onto an object to be attached.

8. The smart electronic device according to claim 1, wherein a battery, a main board and a receiver is provided within the case , the main board and/or display panel are further provided with a keyboard, a camera, a sound control key, an on/off switch, an ear plug socket, a USB socket or an amplifier.

9. The smart electronic device according to claim 1, wherein the hinge is provided with a hinge adjusting component configured to adjust an angle between the bar and the case.

10. The smart electronic device according to claim 1, wherein the bar is provided with a wireless transmission device, the wireless transmission device connects to the case electrically.

11. The smart electronic device according to claim 1, further comprising an adjusting strut, an upper end of the adjusting strut rotatably connects to the display panel or the bar, wherein the back of the case is provided with a plurality of adjusting grooves that couple with the adjusting strut.

12. The smart electronic device according to claim 1, wherein the display panel is a folded display panel, the display panel comprises a plurality of display units that can be folded.

13. The smart electronic device according to claim 4, wherein the smart electronic device has a retracted space for retracting the neck cord and/or waist band.

14. The smart electronic device according to claim 1, further comprising an electronic component for driving a sliding of the bar parts and driving a rotation of the hinge and the rotating plate.

15. The smart electronic device according to claim 2, further comprising an electronic component for driving a rotation of the rotating component.

16. The smart electronic device according to claim 1, wherein the upper end of the distal bar part of the bar connects to the display panel through the rotating plate, which allows the display panel and the distal bar part to be rotatably connected.

17. The smart electronic device according to claim 1, wherein the lower end of the proximal bar part of the bar connects to the case through the hinge, which allows the angle between the display panel and the case to be adjustable.

18. The smart electronic device according to claim 1, wherein a groove is provided to one side of case opposite to the display panel, which allows the bar facing the display panel to retract within the groove when the display panel and the case fold together.
